(19) United States
(12) Patent Application Publication
(10) Pub. No.: US 2006/0250202 A1
(43) Pub. Date: Nov. 9, 2006

(54) Relay structure improvement

(75) Inventor: Sung-Jen Wu, Taipei Hsien (TW)

Correspondence Address: BIRCH STEWART KOLASCH & BIRCH, PO BOX 747, FALLS CHURCH, VA, 22040-0747, US

(73) Assignee: SONG CHUAN PRECISION CO., LTD.

(21) Appl. No.: 11/165,171

(22) Filed: Jun. 24, 2005

(30) Foreign Application Priority Data
May 6, 2005 (TW) 094207293

(51) Int. Cl. H01H 67/02

(52) U.S. Cl. 335/128

(57) ABSTRACT

A relay structure includes an iron core which is winded by a coil at one end and arranged an armature at the other end with proper clearance from the iron core, and one or multiple grooves. According to the structure, the grooves can alter the deployment of the magnetic beam, attain a better magnetic force, and resolve the problem of voltage input of a specific coil to meet the most application requirements from a relay in the market.

### BACKGROUND OF THE INVENTION

I. Field of the Invention

The present invention relates to a device of “Relay Structure Improvement”, more particularly to an apparatus, which can alter the deployment of magnetic beam to attain better magnetic force and resolve the voltage input problem of a specific coil to meet the most application requirement a relay in the current market can provide.

II. Description of the Prior Art

Relay is a kind of control apparatus in our daily life; as usual we name it as switch to fulfill some conditional terms. It is heavily used in many control system, especially those discrete control system. From another viewpoint, an electric circuits for some functional purpose more often than not needs to combine with some other mechanical components for complete performance; in the situation relay plays a role as interface between electric components and mechanical components.

Furthermore, most of conventional electronic appliance receive input alternate voltage and then rectify into half-wave commutation wave shape for usage. Because the wave has zero voltage time, and the magnetic beam of normal conventional iron core is more dispersible and difficult to concentrate; then the phenomena causes the magnetic force of conventional direct current relay weaker, and could not absorb the magnetic pole in a steady way so as to set aside the poor performance and noisy sound, and bring product producer and user much annoyance.

### SUMMARY OF THE INVENTION

It is therefore a primary object of the present invention to provide an apparatus of “Relay Structure Improvement” by which magnetic beam can concentrate to produce better magnetic force, and resolve the voltage input problem of specific coil simultaneously to meet the most application requirements of a relay in the market.

It is a further object of the present invention of “Relay Structure Improvement” that mainly consists of a edge-cut iron core which is characterized by: a coil winded around the outer edge of the edge-cut iron core, and a magnetic pole fitted at one end of the edge-cut iron core with a proper clearance arranged between magnetic pole and edge-cut iron core, and one or multiple edge-cut grooves arranged at the end that nears magnetic pole with a copper piece on it. According to the above-mentioned structure, the edge-cut grooves of the present invention of “Relay Structure Improvement” could alter the deployment of magnetic bean to attain better magnetic force which is proportion to the cross section area of the edge-cut grooves that can alter the deployment of magnetic force depending on the size of cross section area and resolve the voltage input problem of a specific coil to meet the market application requirements of a relay.

### BRIEF DESCRIPTION OF THE DRAWINGS

FIG. 1 shows a perspective view of the present invention.

FIG. 2 shows a perspective view of AC iron core with copper piece

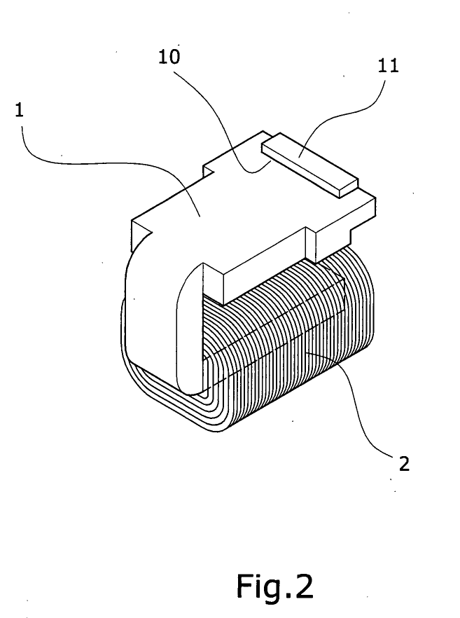

FIG. 3 shows a top perspective view of AC iron core without copper piece

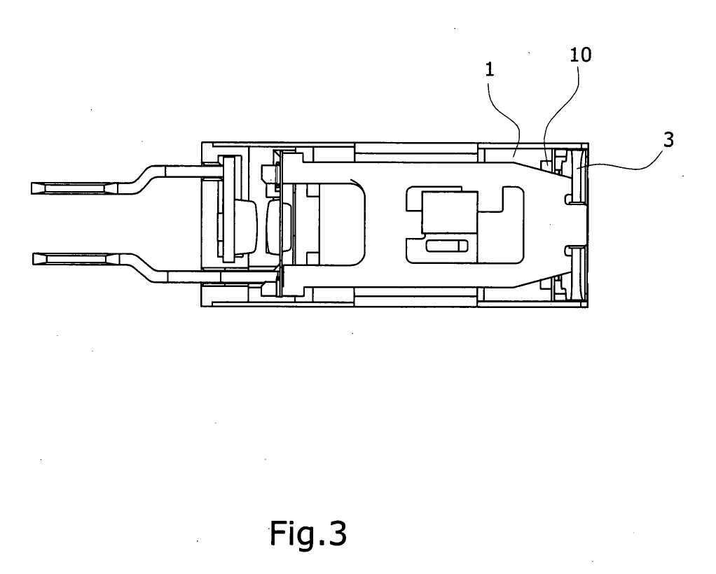

FIG. 3A shows a cross-sectional view of AC iron core with copper piece

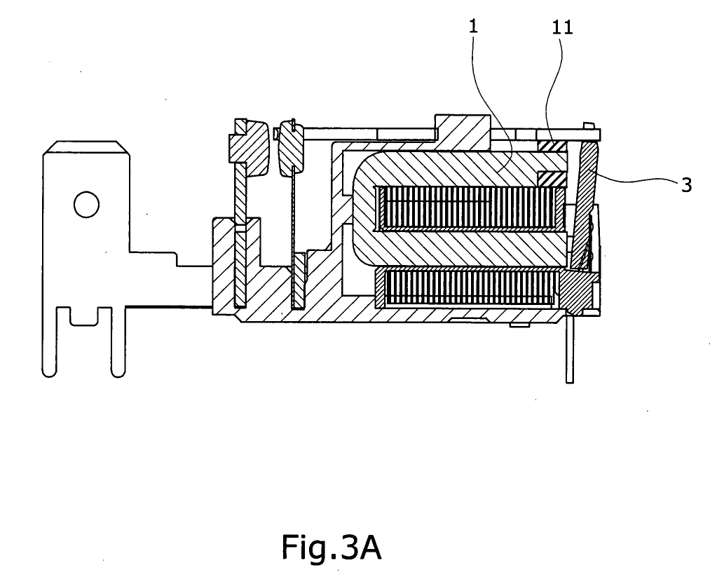

### DESCRIPTION OF THE PREFERRED EMBODIMENTS

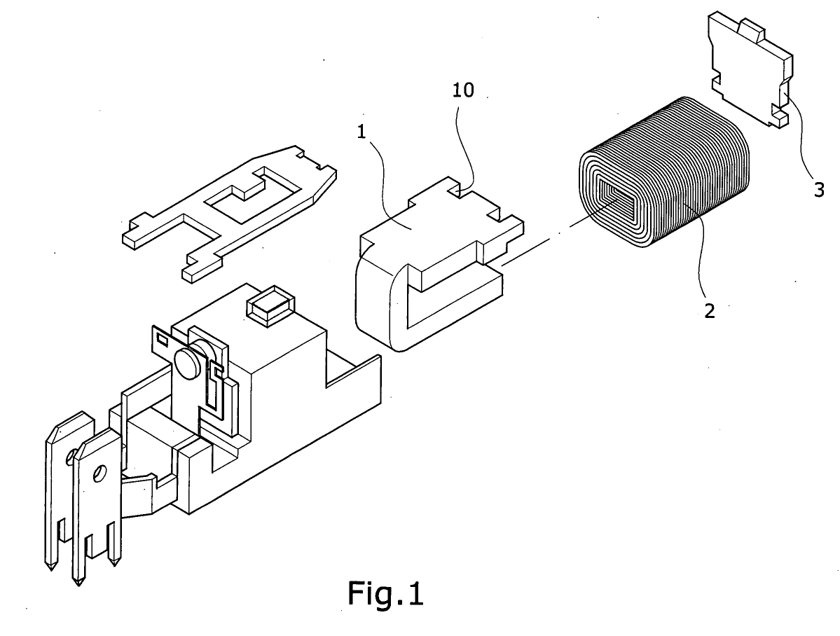

Referring to FIG. 1, 2, 3, 3A, the present invention of “Relay Structure Improvement” mainly consists of a edge-cut iron core 1 which is characterized by: a coil 2 winded around the outer edge of the edge-cut iron core 1, and a magnetic pole 3 fitted at one end of the edge-cut iron core 1 with a proper clearance arranged between magnetic pole 3 and edge-cut iron core 1, and one or multiple edge-cut grooves 10 arranged at the end that nears magnetic pole 3 fixes a copper piece 11 on it. Accordingly, the present invention of “Relay Structure Improvement” use a coil 2 and a magnetic pole 3 in a solid unit to replace with conventional iron core, edge-cut iron core 1 and edge-cut iron core 1 with copper piece 11 for input voltage examination; and the examination result shows that when apply voltage into the coil 2, the magnetic force of edge-cut iron core 1 without copper piece is stronger than that of conventional iron core by the reason of the edge-cut groove 10 altering the deployment of magnetic beam. This truth further prove that the magnetic force is proportion to the size of contacting area, the cross section area of the edge-cut groove could change the deployment of the magnetic beam to gain more magnetic force, and resolve the voltage input problem of specific coil which is key to relay daily application.

Additionally, in contemporary market the direct current relay still use usual conventional iron core which can also be replaced by the edge-cut iron core 1 of the present invention of “Relay Structure Improvement”, and produce more efficient magnetic force, and further improve the half and full wave rectify loop problem of conventional relay at zero voltage and non-zero voltage stage to promote the conventional relay's performance and meet the application requirements of a relay in contemporary market.

In summary, the present invention of “Relay Structure Improvement” could alter the deployment of magnetic beam to attain better magnetic force and resolve the voltage input problem of specific coil to meet the market requirement. Many changes and modifications in the above-described embodiments of the invention can, of course, be carried out without departing from the scope thereof. Accordingly, to promote the progress in science and the useful arts, the invention is disclosed and is intended to be limited only by the scope of the appended claim.

1. A relay structure, comprising:
an iron core, the iron core having an upper portion, a lower portion, and a middle portion extending from a first end of the upper portion and a first end of the lower portion the upper portion being substantially parallel with and the lower portion, the upper portion of the iron core having at least one groove at the second end of the upper portion for changing a distribution of a magnetic beam of the iron core,
a coil wound on the lower portion of the iron core,
an armature facing the second end of the upper portion and the lower portion the armature being apart from the second end of the upper portion and the lower portion.

2. The relay structure of claim 1, wherein the at least one groove includes a plurality of grooves located at the second end of the upper portion for changing the distribution of the magnetic beam of the iron core.

3. The relay structure of claim 1, wherein a copper piece is fitted to the groove.

4. The relay structure of claim 1, wherein the iron core has a U shape.

5. The relay structure of claim 1, wherein the upper portion of the iron core has a bottom groove at a bottom side of the second end of the upper portion.

6. The relay structure of claim 3, wherein the upper portion of the iron core has a bottom groove at a bottom side of the second end of the upper portion.

7. The relay structure of claim 6, wherein the copper piece occupies the bottom groove of the upper portion.

8. The relay structure of claim 7, wherein the copper piece at the bottom groove of the upper portion forms a substantially flat plane with a portion of the bottom groove of the upper portion without the bottom groove.

9. The relay structure of claim 1, wherein the lower portion and the middle portion having a substantially same width, and the upper portion has a larger width than the lower portion and the middle portion.
